(19) United States
(12) Patent Application Publication
(10) Pub. No.: US 2016/0121649 A1
(43) Pub. Date: May 5, 2016

(54) CONNECTOR OF BICYCLE RIM

(71) Applicant: CHU HSIANG TECHNOLOGY CO., LTD., CHANGHUA (TW)

(72) Inventor: KUO-YANG CHANG, CHANGHUA (TW)

(21) Appl. No.: 14/578,652

(22) Filed: Dec. 22, 2014

(30) Foreign Application Priority Data
Nov. 3, 2014 (TW) 103138084

(51) Int. Cl. B60B 25/02; F16B 4/00

(52) U.S. Cl. CPC B60B 25/02; F16B 4/004

(57) ABSTRACT

A connector for connecting opposite ends of a rim tube to form a bicycle rim is provided, wherein the rim tube has an outer side, an inner side, and two lateral sides, and has an opening at each end thereof, and the connector connects the opposite ends of the rim tube by squeezing opposite ends of the connector into the openings of the rim tube. The connector is provided with cuts or slots to make portions between the curs or slots independently flexible. The connector will be deformed to fit the openings of the rim tube automatically when it is squeezed into the openings of the rim tube.

The current application claims a foreign priority to the patent application of Taiwan No. 103138084 filed on Nov. 3, 2014.

### BACKGROUND OF THE INVENTION

1. Technical Field

The present invention relates to a bicycle wheel, and more particularly to a connector for connecting opposite ends of a tube to form a bicycle rim.

2. Description of Related Art

Typically, a conventional bicycle rim is made from an aluminum extrusion tube. The aluminum extrusion tube is bent into a circle, and then a connector is squeezed into ends of the extrusion tube to form a bicycle rim.

Taiwan Utility Model M452874 taught a connector for connecting the annular aluminum extrusion tube. This connector has a curvature that is the same as the annular aluminum extrusion. Therefore, it needs a complex process to manufacture such connectors, so that the cost of the conventional connectors is high. Besides, it is hard to manufacture the connectors having the exact curvature. Because the connector has to tightly fit both ends of the aluminum extrusion tube, the tolerance of such connector is very small, so the yield rate of making the connectors is low, and it is another reason why the conventional connector is expensive.

In addition, any size error, uneven surface, or uneven thickness of the conventional connector might cause the failure of connecting the ends of the aluminum extrusion tube to form the bicycle rim. Therefore, the conventional way of connecting the ends of the aluminum extrusion tube has to be improved.

### BRIEF SUMMARY OF THE INVENTION

In view of the above, the primary objective of the present invention is to provide a connector for connecting opposite ends of an aluminum extrusion tube to form a bicycle rim, which is cheaper, and can firmly connect the opposite ends of an aluminum extrusion tube.

In order to achieve the above objective, the present invention provides a connector for connecting opposite ends of a rim tube to form a bicycle rim, wherein the rim tube has an outer side, an inner side, and two lateral sides, and has an opening at each end thereof, and the connector connects the opposite ends of the rim tube by squeezing opposite ends of the connector into the openings of the rim tube. The connector includes a first portion, a second portion, a third portion, and a fourth portion. The first portion is attached to an inner surface of the outer side, the second portion is attached to an inner surface of the outer side, and the third portion and the fourth portion are attached to inner surfaces of the lateral side when the connector is squeezed into the openings of the rim tube. The connector further includes means for deforming the first portion, the second portion, the third portion, and the fourth portion when the connector is squeezed into the openings of the rim tube.

In an embodiment, the means include two cuts on each of the first portion, the second portion, the third portion, and the fourth portion, the cuts respectively have an end opened at the corresponding end of the connector to make portions between two of the slots at the same end flexible.

In another embodiment, the means include a slots on each of the first portion, the second portion, the third portion, and the fourth portion, the slots respectively have opposite ends opened at the opposite ends of the connector to make portions between two of the slots flexible.

With such design, the connector of the present invention may connect the rime tube successfully without having to worry about the curvature and tolerance when the connectors are manufactured.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is an exploded view of a first preferred embodiment of the present invention, showing the connector and the rim tube;

FIG. 2 is a partial perspective view of the first preferred embodiment of the present invention;

FIG. 3 is a partial perspective view of the first preferred embodiment of the present invention, showing the connector in one end of the rim tube;

FIG. 4 is a partial sectional view of the first preferred embodiment of the present invention, showing the connector being deformed in the rim tube;

FIG. 5 is another partial sectional view of the first preferred embodiment of the present invention;

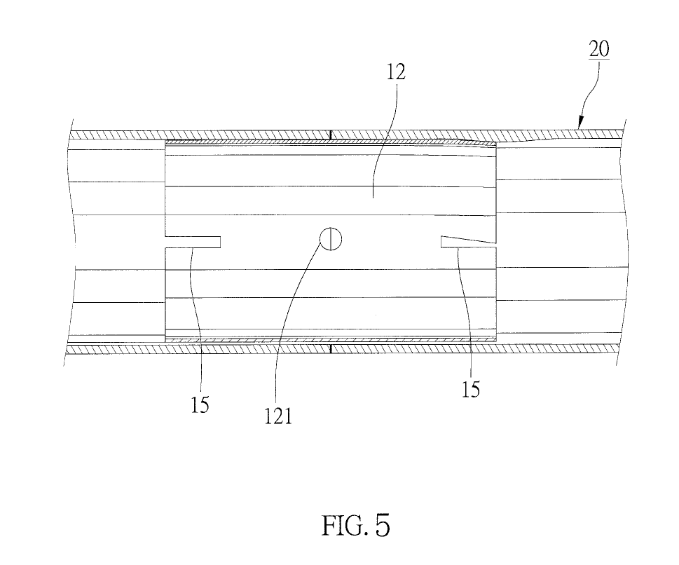

FIG. 6 is a partial perspective view of a second preferred embodiment of the present invention;

FIG. 7 is a partial sectional view of the second preferred embodiment of the present invention, showing the connector being deformed in the rim tube; and

FIG. 8 is another partial sectional view of the second preferred embodiment of the present invention.

### DETAILED DESCRIPTION OF THE INVENTION

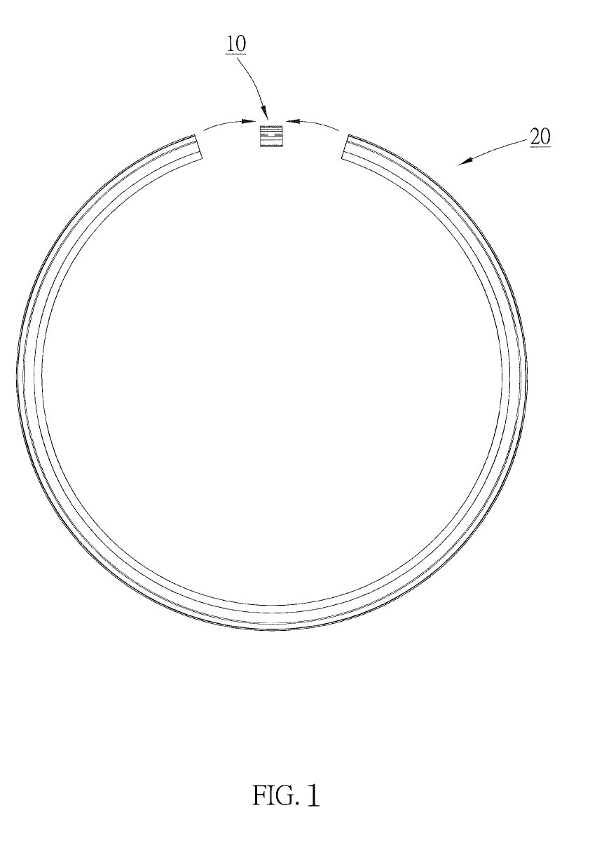

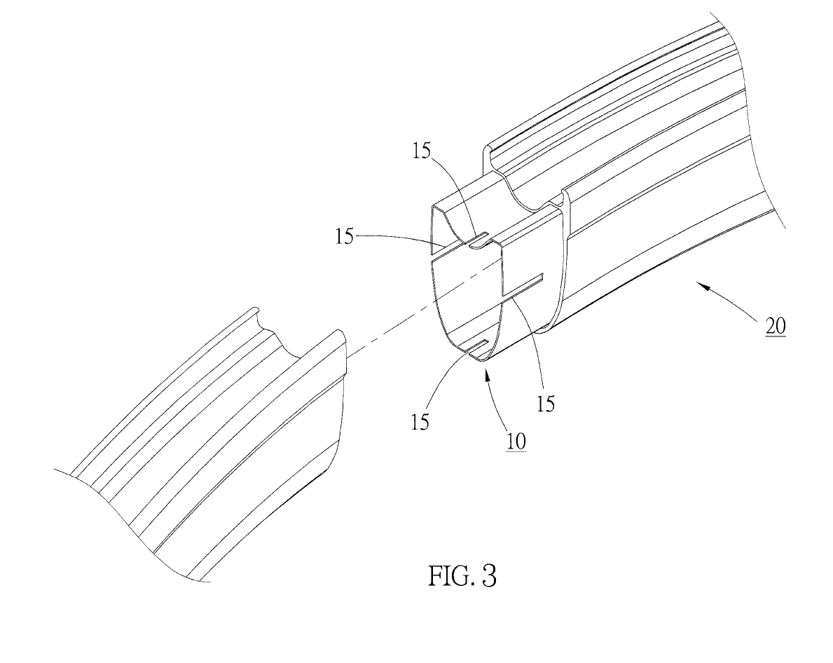

FIG. 1 to FIG. 3 shows a connector 10 of the first preferred embodiment of the present invention, which is adapted to connect opposite ends of a rim tube 20 to form a bicycle rim. The rim tube 20 is an aluminum extrusion tube to be cut and bent to form a ring shape. As shown in FIG, 2 and FIG. 3, the rim tube 20 has an opening 21 on each end thereof, and the connector 10 has its opposite ends squeezed into the openings 21 of the rim tube 20 to form the bicycle rim. The rim tube 20 further has an outer side 22, an inner side 23, and two lateral sides 24. The outer side 22 has a slot to engage a tire (not shown). The inner side 23 is opposite to the outer side 22, and the lateral sides 24 are at right and left sides of the bicycle rim, which connect to the outer side 22 and the inner side 23.

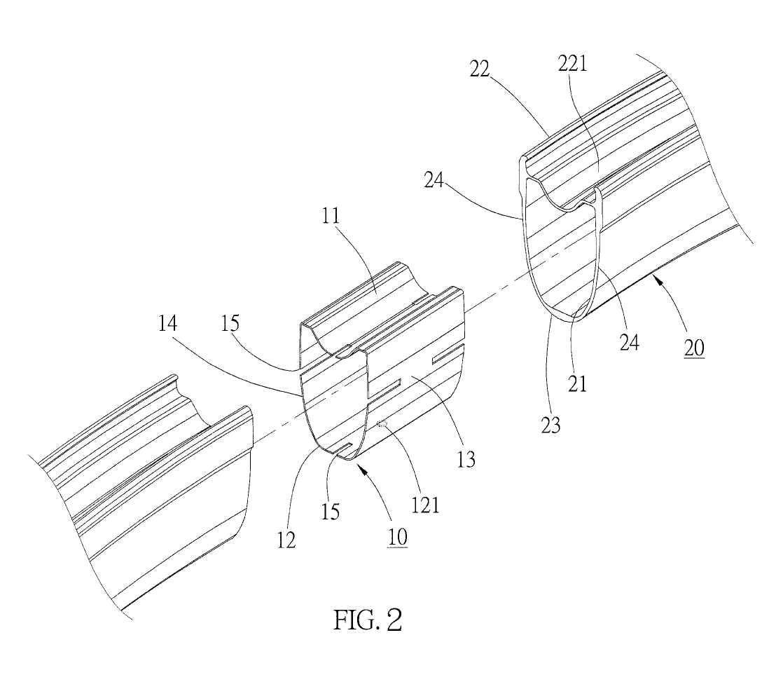

As shown in FIG. 2, the connector 10 is made by an aluminum extrusion tube, having a first portion 11, a second portion 12, a third portion 13, and a fourth portion 14. When the connector 10 is squeezed into the openings 21 of the rim tube 20, the first portion 11 is attached to an inner surface of the outer side 22, the second portion 12 is attached to an inner surface of the inner side 23, and the third and the fourth portions 13 and 14 are attached to inner surfaces of the lateral sides 24 respectively. The connector 10 is provided with means for deforming the portions 11-14 when the connector 10 is squeezed into the openings 21 of the rim tube 20. In the present embodiment, the means include two cuts 15 on opposite ends of each portion 11-14. Each cut 15 is opened at the corresponding end of the connector 10, therefore, portions between two of the slots 15 at the same end are flexible.

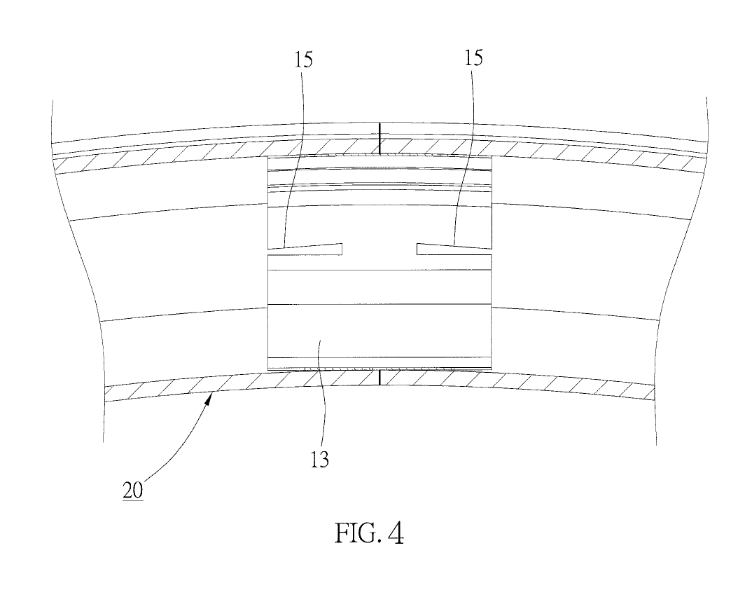

As shown in FIG. 1, FIG. 3, and FIG. 4, when squeezing the connector 10 into the openings 21 of the rim tube 20, the ends of the connector 10 are flexed because of the cuts 15, so that the connector 10 could be squeezed into the openings 21 of the rim tube 20 easily, but still keep the portions 11-14 of the connector 10 tightly attached to inner surfaces of the sides 22-24 of the rim tube 20. It is noted that the connector 10 is preferable to have a half in one of the openings 21 of the rim tube 20, and a half in the other opening 21. In the present embodiment, the connector 10 is provided with an indicator 121 at a center of the second portion 12, which is a bore in the present embodiment, to let the operator have a visual identification for the connector 10 at the even position or not.

As the connector 10 is being squeezed into the openings 21, all portions 11-14 of the connector 10 are flexed inwardly, and the cuts 15 become narrower because of the pressure of the rim tube 20. As a result, the connector 10 is deformed to have a curvature fitting the rim tube 20 automatically, and firmly connect the opposite ends of the rim tube 20 to form a bicycle rim.

If the rim tube 20 has an uneven thickness, which means that the sizes and shapes of the openings 21 are different, the flexures of the opposite ends of the connector 10 will be different accordingly. In other words, the connector 10 will be flexed more in a small opening 21, and flexed less in a big opening 21, and the portions between the cuts 15 may be flexed independently, so that the connector 10 may be squeezed into any opening of the rim tube 20 to connect the rim tube 20 successfully.

In order to make the connector 10 have the curvature identical to the rim tube 20, the flexure of the first portion 11 should be greater than that of the second portion 12. For that purpose, lengths of the cuts 15 on the third and the fourth portions 13, 14 are longer than that on the first and the second portion 11, 12, so that an upper portion of the connector 10 may be flexed more than a lower portion.

The connector 10 is straight before it is squeezed into the rim tube 20, and it is deformed to have a curvature identical to the rim tube 20 automatically when it is squeezed into the openings 21 of the rim tube 20, and the flexure of the connector 10 will be adjusted according to the shape and size of the openings 21 of the rim tube 20. As a result, the connectors 10 of the present invention do not have to worry about the curvature and the tolerance in manufacture process. It has a high yield rate in manufacture, and may successfully connect the rim tube 20 with a high possibility.

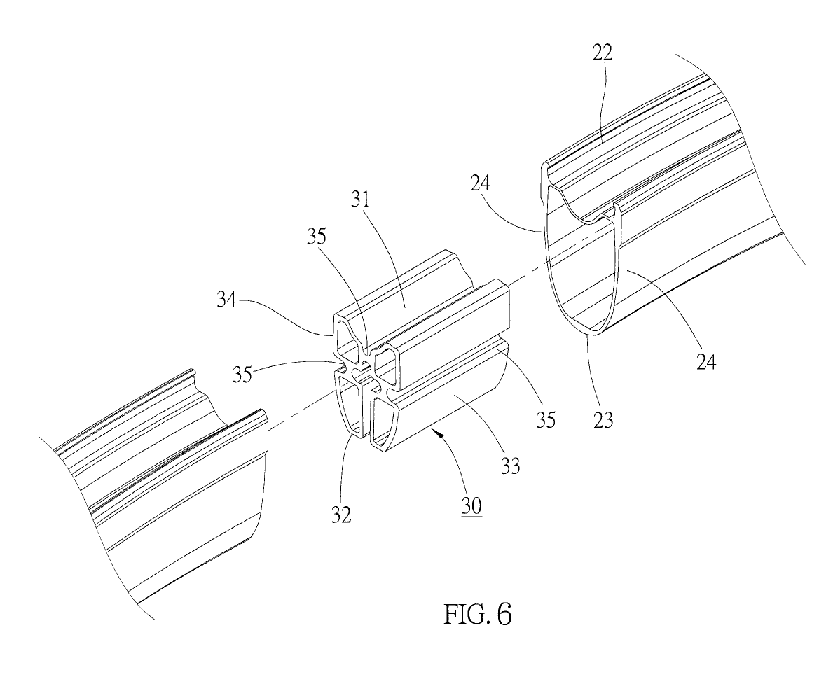

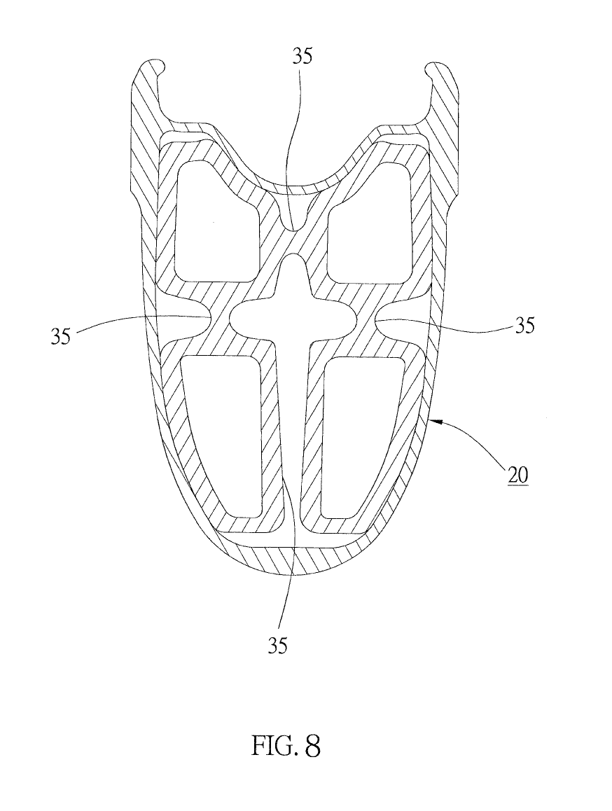

FIG. 6 to FIG. 8 show a connector 30 of the second preferred embodiment, which is made by an aluminum extrusion tube too, and has a first portion 31, a second portion 32, a third portion 33, and a fourth portion 34. The way of connecting opposite ends of the rim tube 20 by the connector 30 of the second preferred embodiment is the same as above, so we do not describe the detail again.

The connector 30 is provided with means for deforming the connector 30 when it is squeezed into the openings 21 of the rim tube 20. The means include a slot 35 on each portion 31-34. The slots 35 are parallel to an axial of the connector 30, and are opened at opposite ends of the connector 30. Therefore, portions between two of the slots 35 are flexible.

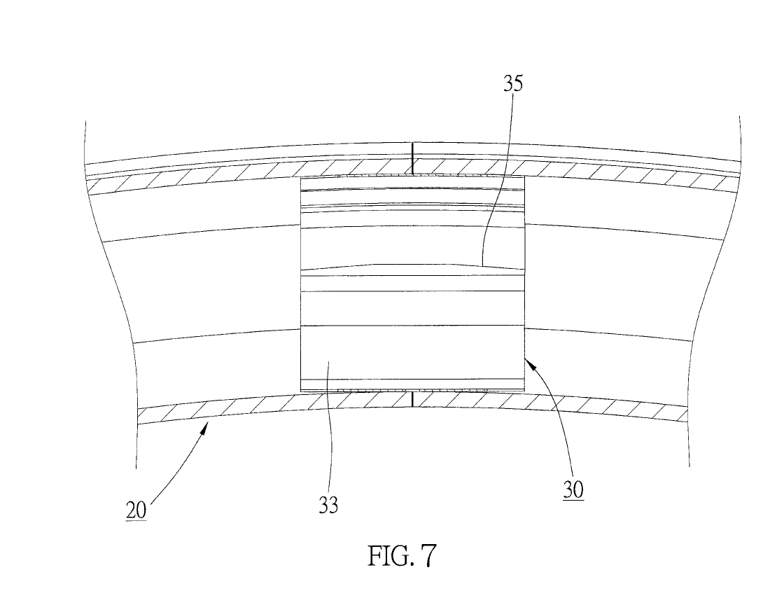

As shown in FIG. 6 and FIG. 7, the connector 30 will be flexed by the pressure of the rim tube 20 when it is squeezed into the openings 21 of the rim tube 20, the flexure of the portions between two of the slots 35 will be adjusted automatically to make the connector 30 have a shape and curvature fitting the openings 21 of the rim tube 20, so that the connector 30 could connect the rim tube 20 to form a bicycle rim successfully.

The same as above, if the rim tube 20 has an uneven thickness, which means that the sizes and shapes of the openings 21 are different, the flexures of the opposite ends of the connector 30 will be different accordingly. In other words, the connector 30 will be flexed more in a small opening 21, and flexed less in a big opening 21, and the portions between the slots 35 may be flexed independently, so that the connector 30 may be squeezed into any opening of the rim tube 20 to connect the rim tube 20 successfully.

The connector 30 is straight before it is squeezed into the rim tube 20, and it is deformed to have a curvature identical to the rim tube 20 automatically when it is squeezed into the rim tube 20, and the flexure of the connector 10 will be adjusted according to the shape and size of the opening 21 of the rim tube 20. As a result, the connector 30 of the present invention does not have to worry about the curvature and the tolerance. It has a high yield rate in manufacture, and may connect the rim tube 20 successfully.

It must be pointed out that the embodiments described above are only some preferred embodiments of the present invention. All equivalent structures which employ the concepts disclosed in this specification and the appended claims should fall within the scope of the present invention.

What is claimed is:

1. A connector for connecting opposite ends of a rim tube to form a bicycle rim, wherein the rim tube has an outer side, an inner side, and two lateral sides, and has an opening at each end thereof, and the connector connects the opposite ends of the rim tube by squeezing opposite ends of the connector into the openings of the rim tube, the connector comprising:
a first portion, a second portion, a third portion, and a fourth portion, wherein the first portion is attached to an inner surface of the outer side, the second portion is attached to an inner surface of the outer side, and the third portion and the fourth portion are attached to inner surfaces of the lateral side when the connector is squeezed into the openings of the rim tube; and
means for deforming the first portion, the second portion, the third portion, and the fourth portion to fit the openings of the rim tube when the connector is squeezed into the openings of the rim tube.

2. The connector of claim 1, wherein the means include two cuts on each of the first portion, the second portion, the third portion, and the fourth portion, the cuts respectively have an end opened at the corresponding end of the connector to make portions between two of the slots at the same end flexible.

3. The connector of claim 2, wherein lengths of the slots on the third portion and the fourth portion are longer than that on the first portion and the second portion.

4. The connector of claim 1, wherein the second portion is provided with an indicator at a center thereof for identifying that the connector has even portions in both the openings of the rim tube.

5. The connector of claim 1, wherein the means include a slots on each of the first portion, the second portion, the third portion, and the fourth portion, the slots respectively have opposite ends opened at the opposite ends of the connector to make portions between two of the slots flexible.
